(19) United States
(12) Patent Application Publication
(10) Pub. No.: US 2026/0189138 A1
(43) Pub. Date: Jul. 2, 2026

(54) POWER CONTROL APPARATUS

(71) Applicant: DENSO CORPORATION, Kariya-city (JP)

(72) Inventor: Keiichi ANDO, Kariya-city (JP)

(73) Assignee: DENSO CORPORATION, Kariya-city (JP)

(21) Appl. No.: 19/544,024

(22) Filed: Feb. 19, 2026

Related U.S. Application Data
(63) Continuation of application No. PCT/JP2024/026096, filed on Jul. 22, 2024.

(30) Foreign Application Priority Data
Aug. 21, 2023 (JP) 2023-134229

(51) Int. Cl. H02M 1/44; H01F 27/24; H01F 27/28; H02M 1/00; H02M 7/00; H02M 7/797

(52) U.S. Cl. CPC H02M 1/44; H01F 27/24; H01F 27/28; H02M 1/0009; H02M 7/003; H02M 7/797

(57) ABSTRACT

A power control apparatus includes a reactor unit and a sensor unit. The reactor unit and the sensor unit are located adjacent to each other in x-direction. A reactor element has a core and a coil. The sensor unit has a current measurement unit. A distance that is shortest between a first core and the current measurement unit is a distance. A distance that is shortest between a second core and the current measurement unit is a distance. Under the adjacency relationship, the distance between the second core, which has no minimum magnetic permeability, and the current measurement unit is shorter than the distance between the first core, also called the other core, and the current measurement unit. By satisfying this distance relationship, the influence from the first core to the current measurement unit is suppressed.

### CROSS REFERENCE TO RELATED APPLICATION

The present application is a continuation application of International Patent Application No. PCT/JP2024/026096 filed on Jul. 22, 2024, which designated the U.S. and is based on and claims the benefit of priority from Japanese Patent Application No. 2023-134229, filed on Aug. 21, 2023, the entire contents of which are incorporated herein by reference.

### TECHNICAL FIELD

The present disclosure relates to a power control apparatus.

### BACKGROUND

A power control apparatus controls electric power. The power control apparatus may include at least one component using electro-magnetic effect. A reactor is one of components using the electro-magnetic effect. Component using the electro-magnetic effect may induce noise in an electric circuit. In the above aspects, or in other aspects not mentioned, there is a need for further improvements in a power control apparatus.

### SUMMARY

Disclosed herein is a power control apparatus controlling electric power, comprising: a conductive member to conduct current to be controlled; a reactor element having a coil electrically connected to the conductive member and a core which passes magnetic flux induced by the coil; and an electrical component in the power control apparatus, which is influenced by leakage flux from the core, wherein the core at least includes: a first core having a first magnetic permeability; and a second core having a second magnetic permeability greater than the first magnetic permeability, wherein the first core and the electrical component form therebetween a first distance as a path of magnetic flux, and wherein the second core and the electrical component form therebetween a second distance as a path of magnetic flux, and wherein the core and the electrical component are arranged so that a distance relationship where the second distance is shorter than the first distance is satisfied.

According to the disclosed power control apparatus, the second core has a second magnetic permeability higher than a first magnetic permeability of the first core. Therefore, the leakage flux from the second core is less than that from the first core. Therefore, due to the magnetic permeability, the leakage flux of the second core has little influence on the electrical component. Furthermore, the reactor element and the electrical component are arranged to satisfy a distance relationship that the first distance is shorter than the second distance. Therefore, due to the distance relationship, influence of the leakage flux from the first core to the electrical component is suppressed.

The disclosed aspects in this specification adopt different technical solutions from each other in order to achieve their respective objectives. Reference numerals in parentheses described in claims and this section exemplarily show corresponding relationships with parts of embodiments to be described later and are not intended to limit technical scopes. The objects, features, and advantages disclosed in this specification will become apparent by referring to following detailed descriptions and accompanying drawings.

### BRIEF DESCRIPTION OF DRAWINGS

FIG. 1 is a block diagram of a power control apparatus according to a first embodiment.

FIG. 2 is a transparent perspective view showing the power control apparatus.

FIG. 3 is a cross-sectional view of a sensor unit.

FIG. 4 is a perspective view of a reactor and the sensor unit in a view along an arrow symbol IV in FIG. 2.

FIG. 5 is a transparent view of the reactor unit and the sensor unit according to a second embodiment.

FIG. 6 is a transparent view of the reactor unit and the sensor unit according to a third embodiment.

FIG. 7 is a transparent view of the reactor unit and the sensor unit according to a fourth embodiment.

FIG. 8 is a transparent view of the reactor unit and the sensor unit according to a fifth embodiment.

FIG. 9 is a transparent view of the reactor unit and the sensor unit according to a sixth embodiment.

FIG. 10 is a transparent view of the reactor unit and the sensor unit according to a seventh embodiment.

FIG. 11 is a transparent view of the reactor unit and the sensor unit according to an eighth embodiment.

FIG. 12 is a transparent perspective view of the reactor unit and the sensor unit according to a ninth embodiment.

FIG. 13 is a transparent cross-sectional view of the reactor unit and the sensor unit according to a tenth embodiment.

### DESCRIPTION OF EMBODIMENTS

JP2019-80021A discloses a reactor. This reactor includes a shielding member that suppresses leakage flux. JP2012-105370A discloses a power control apparatus. This power control apparatus has a reactor and a current sensor. The reactor and the current sensor are located in close proximity to each other. JP6919609B discloses a current sensor. The current sensor includes at least one magnetic shield. The contents of the prior art literature are incorporated herein by reference to explain technical elements in this description.

The reactor in the prior art documents is an electro-magnetic element and therefore produces leakage flux. The leakage flux may influence functions of the electrical component placed in close proximity. Leakage flux may induce noise in electrical circuits by electromagnetic induction. There is concern that such noise may cause adverse effects such as degradation of the electrical component functionality. For example, there is concern that sensor elements, such as temperature and current sensors, may deteriorate in function. Furthermore, elements that use the electro-magnetic effect are more directly susceptible to the leakage flux. For example, current sensors that detect current by using the electro-magnetic effect are concerned about adverse effects such as increased noise components and errors in the detected current. Further improvements are required in the electronic control device in the above respects and in other respects not mentioned above.

It is an object disclosed to provide a power control apparatus in which adverse influence caused by the leakage flux of the reactor are suppressed.

It is another object disclosed to provide a power control apparatus that suppresses performance degradation of a current sensor caused by the leakage flux of the reactor.

A plurality of embodiments are described with reference to the drawings. In some embodiments, functionally and/or structurally corresponding and/or associated elements may be given the same reference numerals, or reference numerals with different digit placed on equal to or higher than a hundred place. With respect to the parts that correspond to or are associated with each other, explanations thereof can be shared among the embodiments.

### First Embodiment

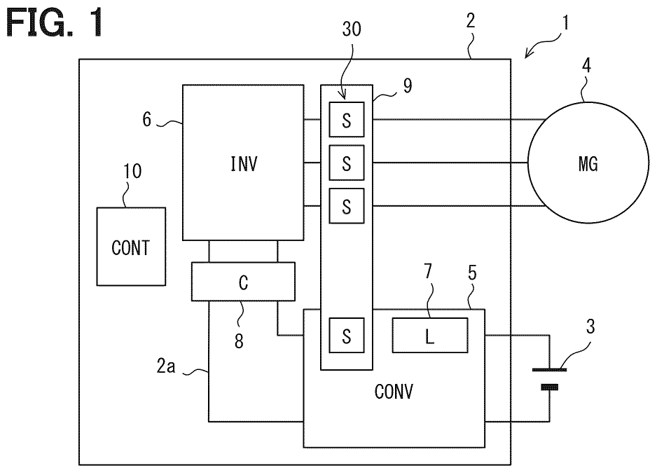

FIG. 1 is a block diagram of a power system 1 for a vehicle. In this embodiment, the vehicle is a ground vehicle. The vehicle is an electric vehicle powered by a rotary electric machine that provides moving power by electric power. The vehicle may additionally include an internal combustion engine that provides moving power by means of fuel. The vehicle may be also called a hybrid vehicle, a plug-in hybrid vehicle, a battery-electric vehicle, etc. The vehicle may be a vessel traveling on water, or an aircraft traveling in the air, or a spacecraft in outer space.

The power system 1 includes a power control apparatus 2. The power control apparatus 2 is electrically connected to and located between the battery 3 and the rotary electric machine 4. The power control apparatus 2 provides bidirectional or unidirectional conversion between a direct current and an alternating current. In addition, the power control apparatus 2 provides DC power regulation and/or AC power regulation. The power control apparatus 2 provides DCAC conversion, which converts DC power supplied from the battery 3 into AC power and supplies it to the rotary electric machine 4. In addition, the power control apparatus 2 provides ACDC conversion, which converts AC power supplied by the rotary electric machine 4 into DC power to charge the battery 3.

The power system 1 includes a battery 3. The battery 3 is a DC power source. In this embodiment, the battery 3 is a rechargeable battery that can be charged and discharged. The DC power sources can utilize a variety of batteries, such as lead-acid batteries, lithium-ion batteries, and nickel-cadmium batteries, for example. Additionally, the DC power may be provided by fuel cells.

The power system 1 includes a rotary electric machine 4. An example of a rotary electric machine 4 is an electric motor. Another example of a rotary electric machine 4 is a generator motor (MG). An example of a rotary electric machine 4 is an AC rotary electric machine. An example of a rotary electric machine 4 is a multi-phase AC rotary electric machine. In this embodiment, the rotary electric machine 4 is a three-phase AC rotary electric machine.

The power control apparatus 2 includes a converter (CONV) 5 and an inverter (INV) 6. The converter 5 and the inverter 6 are connected and arranged in series between the battery 3 and the rotary electric machine 4. The power control apparatus 2 converts electric power. The power control apparatus 2 is also called a power convert apparatus. The power control apparatus 2 includes conductive members 2a for current to be controlled. The conductive members 2a are members for conducting high current to be converted. The conductive members 2a are provided by bus bars. The conductive members 2a may be stretched in a portrait or in a landscape within the power control apparatus 2 to allow efficient current flow. The conductive members 2a are located between the converter 5 and the inverter 6, between the inverter 6 and the rotary electric machine 4, and so on.

The converter 5 has primary ends and secondary ends. In this embodiment, the battery 3 is connected to the primary ends and the inverter 6 is connected to the secondary ends. The converter 5 provides a step-up function that boosts the voltage between the primary ends and the secondary ends. The converter 5 provides a step-down function to step down the voltage between the primary ends and the secondary ends. The converter 5 provides step-up and/or step-down functions. The converter 5 is provided by a chopper circuit. The chopper circuit includes a reactor units (L) 7 and a switching element. The reactor unit 7 is an electro-magnetic element that mutually converts electric power energy and magnetic energy. The converter 5 may be provided by a circuit that includes a transformer. In this case, the transformer is an electromagnetic element.

The inverter 6 has DC ends and AC ends. In this embodiment, the converter 5 is connected to the DC ends and a rotary electric machine 4 is connected to the AC ends. The inverter 6 provides DCAC conversion function, which converts a DC power input to the DC ends into an AC power output to the AC ends. The inverter 6 provides DCAC conversion function, which converts AC power input to the AC ends into a DC power output to the DC ends. The inverter 6 provides the DCAC conversion function and/or the ACDC conversion function. The AC ends include a plurality of terminals corresponding to a multi-phase AC power. In the illustrated example, the AC ends corresponds to a three-phase AC power. The inverter 6 is provided by a bridge circuit containing a plurality of switching arms. The plurality of switching arms are provided by a plurality of switching elements.

The switching elements of the converter 5 and the inverter 6 are provided by the same or different types of elements. The switching elements may be provided by switch modules containing one or more switching elements. The switching elements may be provided by a variety of switching elements, e.g., IGBT, power MOS, SiC elements, etc.

The power control apparatus 2 includes a capacitor unit (C) 8. The capacitor unit 8 includes a capacitor element connected between a positive member and a negative member between the converter 5 and the inverter 6. This capacitor unit 8 performs to smooth the DC power between the converter 5 and the inverter 6.

The power control apparatus 2 includes a sensor unit 9. The sensor unit 9 measures current in current paths in the power control apparatus 2 and outputs electrical signals indicating amount of current. The sensor unit 9 includes at least one current measurement unit 30 for measuring the current in at least one current path. The current measurement unit 30 is one of the electrical component in the power control apparatus 2. The current measurement unit 30 is the electrical component that is influenced by the leakage flux from the core of the reactor element described below. The current measurement unit 30 is an electro-magnetic component that detects the magnetic flux caused by the current flowing in the conductive member. In this embodiment, the sensor unit 9 includes a plurality of current measurement units 30. In this case, the sensor unit 9 is also called a current sensor unit. The plurality of current measurement units 30 include at least a plurality of current measurement units 30 that measure the multi-phase current flowing between the inverter 6 and the rotary electric machine 4. The plurality of current measurement units 30 include at least one current measurement unit 30 that measures the DC current flowing between the converter 5 and the inverter 6. In the illustrated example, the sensor unit 9 has at least four current measurement units 30. The sensor unit 9 outputs a plurality of detection signals. The detection signal from the sensor unit 9 is input to the control circuit 10 described below.

The sensor unit 9 includes a housing formed primarily of electrically insulating resin material. The housing holds the conductive members through which the current to be detected flows. The housing may include a plurality of conductive members. The housing holds several components that make up the current measurement unit 30. The housing may include a plurality of current measurement units 30. Each of the plurality of current measurement units 30 is arranged and functions in correspondence with each of the plurality of conductive members.

The sensor unit 9 may have a plurality of partial units that are separated from each other. Each of the plurality of partial units may include a plurality of conductive members, or two or more. In this case, each of the plurality of partial units includes the current measurement unit 30 corresponding to the conductive member associated with the partial unit. Even in such a case, the power control apparatus 2 includes a sensor units 9 including a plurality of partial units.

The current measurement unit 30 uses electro-magnetic effect. The current measurement unit 30 includes a measurement element. The current measurement unit 30 positions the measurement element to face the conductive member without directly contacting the conductive member through which the current to be measured flows. The current measurement unit 30 outputs an electrical signal indicating the current measured by the measurement element.

The power control apparatus 2 includes a control circuit 10. The control circuit 10 receives electrical signals from the sensor unit 9. The control circuit 10 controls at least one switching element in the converter 5 and the inverter 6. The control circuit 10 controls on timing and/or off timing of the switching element. The control circuit 10 controls the voltage supplied to the rotary electric machine 4 and/or the current supplied to the rotary electric machine 4 by controlling the switching elements. The control circuit 10 controls the voltage supplied to the battery 3 and/or the current supplied to the battery 3 by controlling the switching elements.

The control circuit 2 in this description may also be called as an electronic control unit (ECU). The control circuit may be sometimes referred to as a control system.

The control circuit is provided by a control system that includes at least one computer. The control system may be provided by (a) an algorithm as a plurality of logic called an if-then-else form, or (b) a learned model tuned by machine learning, e.g., an algorithm as a neural network. The control system may include a plurality of computers linked by a data communication device. The computer includes at least one processor (hardware processor) that is hardware. The hardware processor may be provided by the following (i), (ii), or (iii).
(i) The hardware processor may be at least one processor core that executes a program stored in at least one memory. In this case, the computer is provided by at least one memory and at least one processor core. The processor core is called a CPU: Central Processing Unit, a GPU: Graphics Processing Unit, a RISC-CPU, or the like. The memory may be also referred to as a storage medium. The memory is a non-transitory and tangible storage medium, which non-temporarily stores a program and/or data readable by the processor. The storage medium may be a semiconductor memory, a magnetic disk, an optical disk, or the like. The program may be distributed as a single unit or as a storage medium in which the program is stored.
(ii) The hardware processor may be a hardware logic circuit. In this case, the computer is provided by a digital circuit including a number of programmed logic units (gate circuits). The digital circuit is also called a logic circuit array, for example, ASIC: Application-Specific Integrated Circuit, FPGA: Field Programmable Gate Array, SoC: System on a Chip, PGA: Programmable Gate Array, or CPLD: Complex Programmable Logic Device. The digital circuit may include a memory storing programs and/or data. The computer may be provided by an analog circuit. A computer may be provided by a combination of a digital circuit and an analog circuit.
(iii) The hardware processor may be a combination of (i) and (ii). (i) and (ii) may be disposed on different chips or a common chip. In these cases, the portion (ii) may be also called an accelerator.

The control system and control methods implemented by the control system described in this disclosure may be implemented by a dedicated computer provided by configuring a processor and a memory programmed to perform one or more functions embodied by a computer program. Alternatively, the control unit and the method described in the present disclosure may be implemented by a dedicated computer configured as a processor with one or more dedicated hardware logic circuits. Alternatively, the control unit and the method described in the present disclosure may be implemented by one or more dedicated computer, which is configured as a combination of a processor and a memory, which are programmed to perform one or more functions, and a processor which is configured with one or more hardware logic circuits. Furthermore, the computer program may be stored on a computer-readable non-transitory tangible recording medium as instructions executed by a computer.

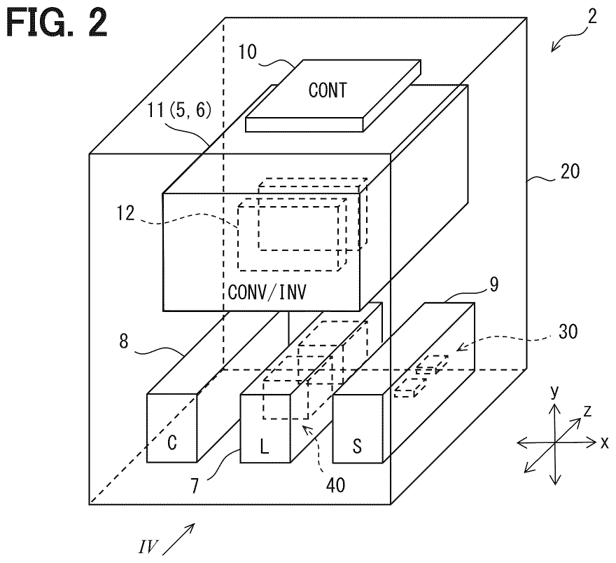

FIG. 2 shows an example of an installation posture of the power control apparatus 2 and an arrangement of components within the power control apparatus 2. As illustrated, the components of the power control apparatus 2 are accommodated in a housing 20. The housing 20 is made of plastic or metal. The housing 20 may be desirably composed of members having an electromagnetic shielding effect from a viewpoint of suppressing electromagnetic noise emitted from the power control apparatus 2 and/or from a viewpoint of suppressing electromagnetic noise arriving from outside the power control apparatus 2.

The power control apparatus 2, i.e., the housing 20, has a three-dimensional shape with an internal cavity that can accommodate a plurality of components. The housing 20 has a three-dimensional shape with a width in a width direction (x-direction), a height in a height direction (y-direction), and a depth in a depth direction (z-direction). FIG. 2 is only one example of the installation posture of the power control apparatus 2. The power control apparatus 2 may be in a variety of installation postures, including a portrait arrangement, a landscape arrangement, and a diagonal arrangement. FIG. 2 is only one example of the arrangement of a plurality of components in the housing 20. The plurality of components may be arranged so that two components are stacked vertically and/or two components are aligned horizontally. The width, height, and depth designations shown in the drawings are for convenience in describing the installation shown in the drawings.

The sensor unit 9 has a plurality of current measurement units 30. The plurality of current measurement units 30 are arranged in rows along a longitudinal direction of the sensor unit 9 and the depth direction (z-direction) in the drawing.

The reactor unit 7 has a plurality of reactor elements 40. The reactor element 40 is an electro-magnetic energy storage element. The plurality of reactor elements 40 are arranged in rows along the longitudinal direction of the reactor unit 7 and the depth direction (z-direction) in the drawing. The plurality of reactor elements 40 may be arranged to form one row or multiple rows.

The components of the power control apparatus 2 include a converter 5 and an inverter 6. In addition, the components of the power control apparatus 2 include a reactor unit 7, a capacitor unit 8, a sensor unit 9, and a control circuit 10. The reactor unit 7 and the capacitor unit 8 are also circuit elements of the converter 5. The converter 5 and the inverter 6 include a plurality of switching elements that are their main circuit elements. The power control apparatus 2 includes a heat dissipation module 11 for heat dissipation from these switching elements.

The plurality of switching elements are integrated into the heat dissipation module 11. For example, the plurality of switching elements may be provided by a plurality of switch modules 12. One switch module 12 may be provided by a semiconductor package with a rectangular, flat appearance. The heat dissipation module 11 is arranged to be in contact with one or both sides of the plurality of switch modules 12 to allow heat dissipation from one or both sides of the plurality of switch modules 12. The heat dissipation module 11 defines media passages to flow thermal medium. The heat dissipation module 11 provides heat exchange between the plurality of switch modules 12 and the thermal medium. The power system 1 includes a thermal medium circulation path, which is located outside of the power control apparatus 2. The thermal medium circulation path includes a heat exchanger that cools the heat medium. The thermal medium receives heat from the heat dissipation module 11 by flowing through the heat dissipation module 11. Furthermore, the thermal medium flows through the heat exchanger and releases heat as it flows through the thermal medium circulation path. For example, heat from the thermal medium is dissipated to an outside air. Heat from the thermal medium may be dissipated via the refrigeration cycle.

As illustrated in FIG. 2, the components of the power control apparatus 2 are arranged adjacent to each other in the housing 20. A shape of the housing 20 and a layout of the components within the housing 20 are set according to various requirements. One of the various requests is to be able to mount the power system 1. One of the various requirements is to suppress Joule heat inside the power control apparatus 2. One of the various requirements is to suppress inductance components and/or capacitance components that affect the high-frequency characteristics of the power control apparatus 2. Therefore, it should be understood that the layout of the components illustrated in FIG. 2 is only exemplary, and the layout of the components may be varied.

The reactor unit 7 and the sensor unit 9 may be located adjacent to each other with respect to any direction. In the illustration, the reactor unit 7 and the sensor unit 9 are located adjacent to each other with respect to the width direction (x-direction). The reactor unit 7 and the sensor unit 9 are also adjacent to each other with respect to the diagonal direction between the width direction (x-direction) and the depth direction (z-direction). However, the direction that defines the shortest distance, i.e., the width direction (x-direction), is defined here as the adjacent direction.

The reactor unit 7 and the sensor unit 9 are arranged so that the reactor element 40 and the current measurement unit 30 may be adjacent with respect to any direction. As a result, the reactor element 40 and the current measurement unit 30 may be located adjacent to each other with respect to any direction. In the illustrated example, the reactor element 40 and the current measurement unit 30 are located adjacent to each other with respect to the width direction (x-direction). The reactor element 40 and the current measurement unit 30 are also adjacent to each other with respect to the diagonal direction between the width (x-direction) and depth (z-direction). However, the direction that defines the shortest distance, i.e., the width direction (x-direction), is defined here as an adjacent direction.

The reactor unit 7 and the sensor unit 9 are adjacent to each other so that an outer wall surface of the reactor unit 7 is positioned parallel to an outer wall surface of the sensor unit 9. This arrangement allows the reactor element 40 and the current measurement unit 30 to be placed close to each other. Furthermore, this arrangement contributes to a smaller body size of the power control apparatus 2. The reactor unit 7 and the sensor unit 9 may be positioned so that the outer wall surface of the reactor unit 7 and the outer wall surface of the sensor unit 9 face each other in a non-parallel manner.

A resin member providing the housing for the reactor unit 7 and/or the sensor unit 9 is disposed between the reactor element 40 and the current measurement unit 30.

In FIG. 2, the reactor unit 7 and the switch module 12 may be adjacent with respect to any direction. The reactor unit 7 and the switch module 12 are adjacent to each other with respect to the height direction (y-direction). The switch module 12 may include one or more temperature sensors. One or more temperature sensors measure a temperature of one or more portions in the switch module 12 and output a temperature signal indicating the temperature. The temperature signal is input to the control circuit 10. The control circuit 10 performs temperature control based on the temperature signal to protect the switch module 12 and the switching elements. Temperature control is performed on the converter 5 and/or the inverter 6.

The temperature sensor may be adversely influenced by the leakage flux from the reactor element 40. For example, the leakage flux may electromagnetically influence the detection characteristics of the temperature sensor. The leakage flux may also inductively heat the temperature sensor and change the measured value of the temperature sensor. In these cases, the temperature sensor is influenced by the leakage flux of the reactor elements 40.

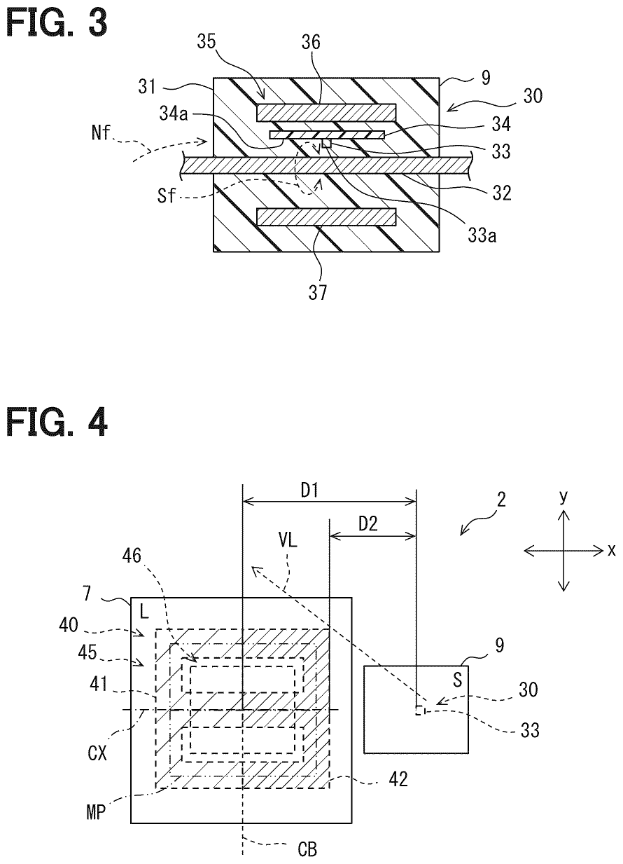

FIG. 3 shows a cross-section of the sensor unit 9. The sensor unit 9 includes a housing 31. The housing 31 holds a plurality of components that make up the current measurement unit 30. The housing 31 holds a conductive member 32. The housing 31 may include a plurality of conductive members 32. The housing 31 may include a plurality of current measurement units 30. One current measurement unit 30 is associated with one conductive member 32. The current measurement unit 30 is positioned at a predetermined position with respect to the conductive member 32 so as to produce a measurement signal indicating a predetermined current value when a predetermined current flows through the conductive member 32.

The current measurement unit 30 includes a sensor element 33. The sensor element 33 measures current flowing in the conductive member 32 using the electro-magnetic function. For example, the sensor element 33 generates a measurement signal in response to the magnetic flux Sf generated around the conductive member 32 in response to current flowing in the conductive member 32. The sensor element 33 provides a magnetoelectric converter that converts magnetic flux into an electrical signal. The magnetoelectric converter includes a magneto-resistive element. The sensor element 33 is provided by a semiconductor chip. The current measurement unit 30 has a circuit board 34 on which the sensor element 33 is mounted. The circuit board 34 provides a positioning component that positions the sensor element 33 with high precision. The circuit board 34 has circuitry for the sensor element 33. The circuit board 34 contains a drive circuitry to make the sensor element 33 works. In addition, the circuit board 34 includes a processing circuitry that processes the measurement signals output by the sensor element 33.

The sensor element 33 includes a magnetic element 33a that is influenced by the leakage flux from the reactor element. The circuit board 34 includes a circuit 34a, which may be influenced by the leakage flux from the reactor element. The circuit 34a may be understood as a circuit pattern formed on the circuit board 34. Furthermore, in this embodiment, the current measurement unit 30 has both a magnetic element 33a and a circuit 34a. Alternatively, the current measurement unit 30 may be configured with only one of the magnetic element 33a and the circuit 34a.

The current measurement unit 30 includes magnetic shield members 35. The current measurement unit 30 may not include the shield member 35. The shield member 35 is an optional component that may be employed selectively. Compared to the shield member 35, the housing 31 and the circuit board 34 function much less as a magnetic shield. The shield member 35 is made of ferromagnetic material such as electromagnetic steel plate, for example. The magnetic flux Sf may be called the internal magnetic flux generated in the conductive member 32 and measured by the sensor element 33. In this case, the magnetic flux reaching at the current measurement unit 30 from outside the current measurement unit 30 may be called the external magnetic flux Nf.

The shield member 35 functions as a magnetic guide member that guides the magnetic flux Sf. The shield member 35 stabilizes the magnetic flux Sf that crosses the sensor element 33. For example, the sensor element 33 may have a measurement axis that measures magnetic flux in a particular direction. The shield member 35 stabilizes the magnetic flux in the measurement axis among the magnetic flux that tries to cross the sensor element 33. In other aspects, the shield member 35 traps the external magnetic flux Nf. As a result, the shield member 35 suppresses influence of the external magnetic flux Nf on the sensor element 33.

The shield member 35 may have a first shield member 36 and a second shield member 37. The conductive member 32 and the sensor element 33 generate an internal magnetic flux Sf and form a pair of components that measure the internal magnetic flux Sf. The components in a pair are arranged so that they face each other with respect to a predetermined facing direction. The first shield member 36 and the second shield member 37 are positioned in this facing direction to sandwich the pair of components from outside of the pair of components. The shield member 35 may be formed by a single member. For example, the shield member 35 may include only one of the first shield member 36 or the second shield member 37. For example, the shield member 35 may be provided by a single continuous member that includes a member corresponding to the first shield member 36 and the second shield member 37.

The disclosure of Patent No. JP6919609B may be incorporated by reference for the current measurement unit 30, the sensor element 33, and the shield member 35.

FIG. 4 shows a cross-section of the reactor unit 7 and the sensor unit 9 in the x-y plane. The reactor unit 7 and the sensor unit 9 are located adjacent to each other with respect to the width direction (x-direction). A distance between the reactor unit 7 and the sensor unit 9 is close enough that the leakage flux of the reactor element 40 reaches the current measurement unit 30. The distance between the reactor unit 7 and the sensor unit 9 is close enough that the leakage flux of the reactor element 40 crosses to the sensor element 33.

The reactor element 40 and the current measurement unit 30 are arranged adjacent to each other with no member between them, other than the shield member 35, that can function as an electromagnetic shield. Under this arrangement, the leakage flux from the reactor element 40 may influence the current measurement unit 30. For example, the leakage flux may alter the flux distribution in the current measurement unit 30. The leakage flux may also be detected directly in the current measurement unit 30. In these cases, the current measurement unit 30, which uses electro-magnetic action, is influenced by the leakage flux of the reactor element 40.

Here, the current measurement unit 30 may include the shield member 35. However, even if the leakage flux only reaches the shield member 35, the magnetic flux crossing the sensor element 33 may be changed. Therefore, the following embodiment also takes into account the influence of the leakage flux of the reactor element 40 when it reaches the current measurement unit 30, including the shield member 35. The current measurement unit 30 illustrated in FIG. 4 may be used as the position of the sensor element 33 to evaluate the distance and other factors described below.

The reactor element 40 includes a core 45 and a coil 46. The coil 46 is electrically connected to the conductive member 2a. The coil 46 has a conductive member wound around the coil axis CX. In the illustrated example, the coil axis CX is positioned along the x-direction. The coil axis CX is positioned to orient toward the current measurement unit 30. The coil axis CX is positioned to cross the current measurement unit 30. The coil axis CX is positioned to cross the sensor element 33. The coil 46 shown has a single coil portion. Alternatively, the coil 46 may have a plurality of coil portions. For example, it is possible to provide a plurality of coil portions, such as two or three, in the magnetic path portions formed by the core 45 described below.

The core 45 passes the magnetic flux induced by the coil 46. The core 45 is provided by two E-type cores. The core 45 is also called the EE core. The two E-type cores are arranged to represent E shapes in the x-y plane. The two E-shaped cores are arranged and connected so that the three ends of one E-shaped core are opposite the three ends of the other E-shaped core. The core 45 forms a magnetic path MP through which the magnetic flux induced in the coil 46 passes when current flows through the coil 46. The core 45 may be provided by a variety of layouts, including the EE core. For example, a variety of cores may be employed as a replacement for the EE core, including the EI core, the UI core, the UU core, the OI core, and the UIU core. The core 45 may be provided by a variety of materials, such as laminated electromagnetic steel sheets, pressed compounds, etc.

In FIG. 4, the magnetic path MP is shown by a double-dashed line. The core 45 forms the magnetic path MP that is a closed path. The core 45 is a gapless core. The core 45 includes a plurality of cores. The core includes a first core 41 and a second core 42. A junction boundary between the first core 41 and the second core 42 is positioned within the coil 46. However, the core 45 produces the leakage flux.

The core 45 forms the magnetic path MP. The magnetic path MP extends along the x-y plane. The magnetic path MP may contain a plurality of magnetic path portions. Furthermore, the magnetic path MP includes a common magnetic path and a plurality of individual magnetic paths. The common magnetic path is a magnetic path common to the plurality of magnetic paths. A plurality of individual magnetic paths are magnetic paths that characterize each of the plurality of magnetic paths. In the illustrated example, the coil 46 is located on the common magnetic path. The coil 46 may have a plurality of coil portions. In this case, the plurality of coil portions may be distributed in a common magnetic path and/or the plurality of individual magnetic paths.

The first core 41 and the second core 42 have different magnetic permeabilities M. The magnetic permeability M1 of the first core 41 is lower than the magnetic permeability M2 of the second core 42 (M1<M2). The magnetic permeability M1 of the first core 41 and the magnetic permeability M2 of the second core 42 are set to adjust the electro-magnetic characteristics as the reactor element 40. The magnetic permeability M1 is also called the first magnetic permeability. The magnetic permeability M2 is also called the second magnetic permeability. For example, a difference between the magnetic permeability M1 of the first core 41 and the magnetic permeability M2 of the second core 42 adjusts an inductance of the reactor element 40. For example, a difference between the magnetic permeability M1 of the first core 41 and the magnetic permeability M2 of the second core 42 adjusts a saturation magnetic flux density. The core 45 may have an air gap at their boundary.

Due to the magnetic permeability M1 and the magnetic permeability M2, a flux density of the leakage flux around the first core 41 is higher than a flux density of the leakage flux around the second core 42. As a result, there is concern about the influence of the leakage flux from the first core 41 to the function of the electrical component located adjacent to the first core 41. The influence may be evaluated by frequency of influence, magnitude of influence, duration of influence, etc. The influence of the electrical component located adjacent to the first core 41 due to the leakage flux from the first core 41 is also referred to as the first influence.

Due to the magnetic permeability M1 and the magnetic permeability M2, a flux density of the leakage flux around the second core 42 is lower than a flux density of the leakage flux around the first core 41. As a result, the influence of the leakage flux from the second core 42 to the function of the electrical component located adjacent to the second core 42 is relatively low. The influence that the electrical component located adjacent to the second core 42 receive due to the leakage flux from the second core 42 is also referred to as the second influence. The term relative is based on a comparison of first influence with second influence.

The first core 41 has the magnetic permeability M1 that is the smallest in the core of the reactor element 40. The second core 42 has the magnetic permeability M2 that is not the minimum in the core of the reactor element 40. The first core 41 may be considered as another core having a magnetic permeability different from the second core 42. The first core 41 is also another core having lower magnetic permeability than the second core 42.

In the following explanation, the current measurement unit 30 is used as an example of an electrical component in order to advance. The skilled person should understand that the current measurement unit 30 may be read as an electrical component. Furthermore, those skilled in the art should understand that the current measurement function may be read into the function of the electrical component. The electrical component is a component that may receive the influence by the leakage flux. The electrical component may include, e.g., inductance elements, capacitance elements, or resistance elements. In addition, the electrical component may have a variety of functions, such as temperature measurement and submersion detection. Furthermore, the electrical component may take a variety of implementing forms, including semiconductor devices, surface mount elements, and through-hole mount elements.

The leakage flux from the first core 41 influences the current measurement function of the current measurement unit 30, which is located adjacent to the first core 41. The influence may be observed as a noise in the output signal from the current measurement unit 30, uneven distribution of the output signal, etc. The leakage flux from the second core 42 influences the current measurement function of the current measurement unit 30, which is located adjacent to the second core 42. The influence on the current measurement function of the current measurement unit 30 located adjacent to the second core 42 is relatively smaller than the influence on the current measurement function of the current measurement unit 30 located adjacent to the first core 41. The relative smallness of the influence may be recognized by the smallness of the noise in the output signal from the current measurement unit 30 or the smallness of the uneven distribution of the output signal.

FIG. 4 illustrates a boundary CB between the first core 41 and the second core 42. In the illustrated example, the boundary CB is one of the y-z planes. The boundary CB is also a boundary surface between an area where the first core 41 is present and an area where the second core 42 is present. The boundary surface is defined by a plurality of connecting surfaces between the first core 41 and the second core 42, and hypothetical surfaces that radially extend outward from those connecting surfaces. The current measurement unit 30 is located in the area where the second core 42 is present. In other words, the current measurement unit 30 is unevenly arranged to a side of a region where the second core 42 is present with respect to the boundary CB. The core 45 defines the boundary CB that separates the region where the first core 41 is located from the region where the second core 42 is located. The current measurement unit 30 is unevenly arranged to the side of the region where the second core 42 is located with respect to the boundary CB.

An uneven arrangement of the current measurement unit 30 with respect to the boundary CB is referred to as an unevenly distributed relationship. In one aspect, the influence from the other core (the first core 41) to the electrical component (the current measurement unit 30) is suppressed by satisfying this distance relationship.

In FIG. 4, the reactor element 40 and the current measurement unit 30 are adjacent on the x-y plane. The reactor element 40 and the current measurement unit 30 are located adjacent to each other with respect to the x-direction. In other words, the shortest distance between the reactor element 40 and the current measurement unit 30 is defined in the x-direction. The x-direction is also referred to as the adjacent direction of the reactor element 40 and the current measurement unit 30. The minimum distance between the reactor element 40 and the current measurement unit 30 may be given by the distance between a surface of the core of the reactor element 40 and a surface of the sensor element 33 of the current measurement unit 30. The shortest distance between the reactor element 40 and the current measurement unit 30 is also the shortest distance of the magnetic flux path where the magnetic flux leaving from the reactor element 40 reach to the current measurement unit 30.

Considering the spatial arrangement, the specific reactor element 40 and the specific current measurement unit 30 are in an adjacency relationship. They are located at the shortest possible spatial distance. For example, a spatial distance between the other reactor element 40 in the reactor unit 7 and the specific current measurement unit 30 is longer than the minimum distance described above. For example, a spatial distance between the other current measurement unit 30 in the sensor unit 9 and the specific reactor element 40 is longer than the minimum distance described above.

The shortest distance between the first core 41 and the current measurement unit 30 is the distance D1. The shortest distance between the second core 42 and the current measurement unit 30 is the distance D2. The distances D1 and D2 are defined as the distances in the x-direction, i.e., the distances in the adjacent direction. The distance D1 and D2 are also the distance of the magnetic flux path reaching to the current measurement unit 30 from the reactor element 40 via the shortest flux path. The distance D2 is shorter than the distance D1. As a result, the influence that the current measurement unit 30 (the electrical component) receives from the reactor element 40 is relatively small.

Under the adjacency relationship, the distance D2 between the second core 42 and the electrical component, whose magnetic permeability is not minimum, is shorter than the distance D1 between the other core (the first core 41) and the electrical component.

An arrangement characterized by the distance D1 between the first core 41 and the current measurement unit 30 and the distance D2 between the second core 42 and the current measurement unit 30 in this embodiment is also referred to as a distance relationship in the following description. In one aspect, the influence from the other core (the first core 41) to the electrical component (the current measurement unit 30) is suppressed by satisfying this distance relationship.

The second core 42 is arranged between the current measurement unit 30 and the first core 41. Moreover, the second core 42 is arranged to completely cover the first core 41 from the current measurement unit 30. This relationship is satisfied both in the x-y plane, which is shown in the drawing, and in the x-z plane, which is not shown. For example, assume that the first core 41 and the second core 42 are seen from the current measurement unit 30 in a transparence manner. Under this assumption, the first core 41 is completely covered by the second core 42.

In FIG. 4, a hypothetical view line VL is indicated by a dashed line. The view line VL can reach the second core 42, but cannot reach the first core 41. Assuming a magnetic flux path, a leakage flux from the first core 41 may detour the second core 42 and reach the current measurement unit 30. In this case, the leakage flux requires a relatively long detour path. Therefore, the influence via a detour path is smaller than the influence via the distances D1 or D2 along a straight line. Thus, the second core 42, which has a relatively high magnetic permeability M2, is also a cover member that covers the electrical component (the current measurement unit 30) from the first core 41, which has a relatively low magnetic permeability M1. Thus, in this embodiment, the second core 42 is located between the first core 41 and the current measurement unit 30. This prevents reaching along a straight line from the first core 41 to the current measurement unit 30.

The arrangement of the second core 42 between the first core 41 and the current measurement unit 30 in this embodiment is also referred to as a cover relationship in the following description. In one aspect, the influence from the other core (the first core 41) to the electrical component (the current measurement unit 30) is suppressed by satisfying the cover relationship.

According to this embodiment, the flux leakage from the core with a non-minimum magnetic permeability M2 in the core of the reactor element 40 (the second core 42) is relatively small. Therefore, the influence from the core (the second core 42) having a non-minimum magnetic permeability M2 in the core of the reactor element 40 to the electrical component (the current measurement unit 30) is small. On the other hand, by satisfying only at least one of the unevenly distributed relationship, the distance relationship, and the cover relationship, the influence on the electrical component (the current measurement unit 30) caused by leakage flux from the core (the first core 41) with a lower magnetic permeability M1 than the second core 42 is suppressed. In this embodiment, the unevenly distributed relationship, the distance relationship, and the cover relationship are all satisfied. As a result, the influence on the electrical component (current measurement unit 30) caused by the leakage flux from the reactor element 40 is suppressed.

According to the embodiment described above, in a power control apparatus 2, where the components must be adjacent to each other, it is possible to suppress the influences on the electrical component other than the reactor caused by the leakage flux from the reactor. Moreover, the reactor element 40 may have desirable electro-magnetic characteristics by having a plurality of cores with different magnetic permeability. Thus, the influence of the leakage flux on other electrical component can be suppressed while improving the electro-magnetic characteristics of the reactor. Furthermore, characteristics and functions as a power control apparatus can be improved.

### Second Embodiment

This embodiment is a modified embodiment of the preceding embodiment which is provided as a basic embodiment. In the subsequent embodiments described below, parts that are the same as those in the preceding embodiments and parts that provide equal functions are marked with the same symbol. The description of those parts can be referred to the description of the preceding embodiments.

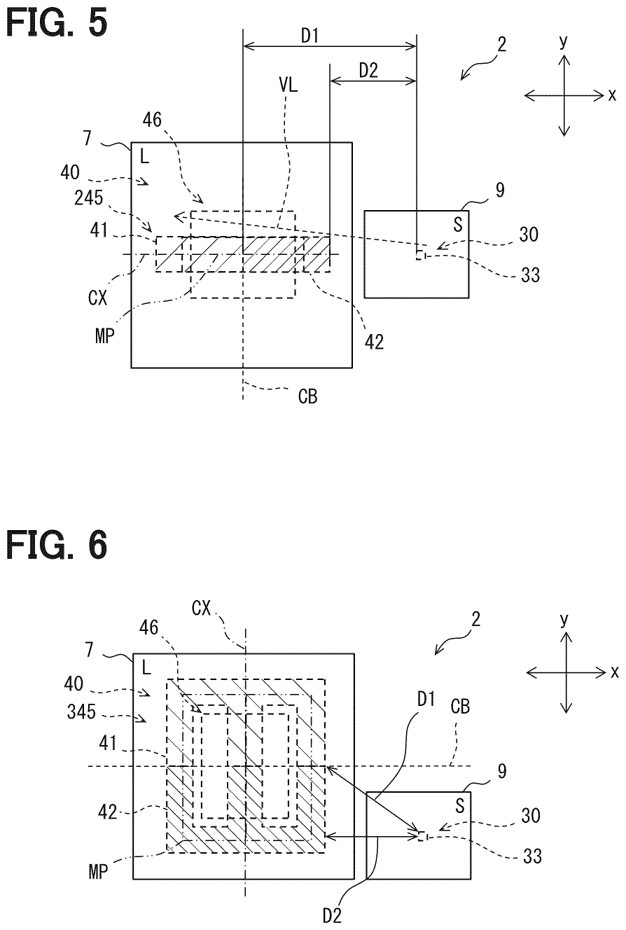

FIG. 5 shows the second embodiment. In the first embodiment, the core 45 is arranged so that the magnetic path MP extends along the x-y plane. Alternatively, in the second embodiment, the core 245 is arranged so that the magnetic path MP extends along the x-z plane. In this embodiment, the coil axis CX is also positioned to orient toward the current measurement unit 30. In this embodiment, too, the unevenly distributed relationship, the distance relationship, and the cover relationship are all satisfied. As a result, functions and effects similar to the preceding embodiments are obtained.

### Third Embodiment

This embodiment is a modified embodiment of the preceding embodiment which is provided as a basic embodiment.

FIG. 6 shows the third embodiment. In the first embodiment, the core 45 is arranged so that the core axis CX orients toward the current measurement unit 30. Alternatively, in the third embodiment, the core 345 is arranged so that the core axis CX does not orient toward the current measurement unit 30. In the first embodiment, the core 345 is arranged so that the magnetic path MP extends along the x-y plane. The core 345 may be arranged so that the magnetic path MP extends along the x-z plane.

In this embodiment, the current measurement unit 30 is adjacent to both the first core 41 and the second core 42. However, with respect to the distance D1 and the distance D2, the core 345 is unevenly arranged closer to the second core 42 than the first core 41.

The shortest distance between the first core 41 and the current measurement unit 30 is the distance D1. The distance D1 is defined as an oblique distance that intersects both the x-direction and the y-direction in the x-y plane.

The core 345 is arranged so that the second core 42 and the current measurement unit 30 are adjacent to each other with respect to the x-direction. In other words, the second core 42 and the current measurement unit 30 are arranged to define the shortest distance D2. A distance between the second core 42 and the current measurement unit 30 is the distance D2. The distance D2 is defined as the distance in the x-direction, i.e., the shortest distance in the adjacent direction.

The distance D2 is shorter than the distance D1. As a result, the influence that the current measurement unit 30 (the electrical component) receives from the reactor element 40 is relatively small.

In this embodiment, too, the unevenly distributed relationship, and the distance relationship described above are satisfied. On the other hand, in this embodiment, the cover relationship described above is not satisfied. According to this embodiment, functions and effects based on the unevenly distributed relationship and the distance relationship are obtained.

### Fourth Embodiment

This embodiment is a modified embodiment of the preceding embodiment which is provided as a basic embodiment.

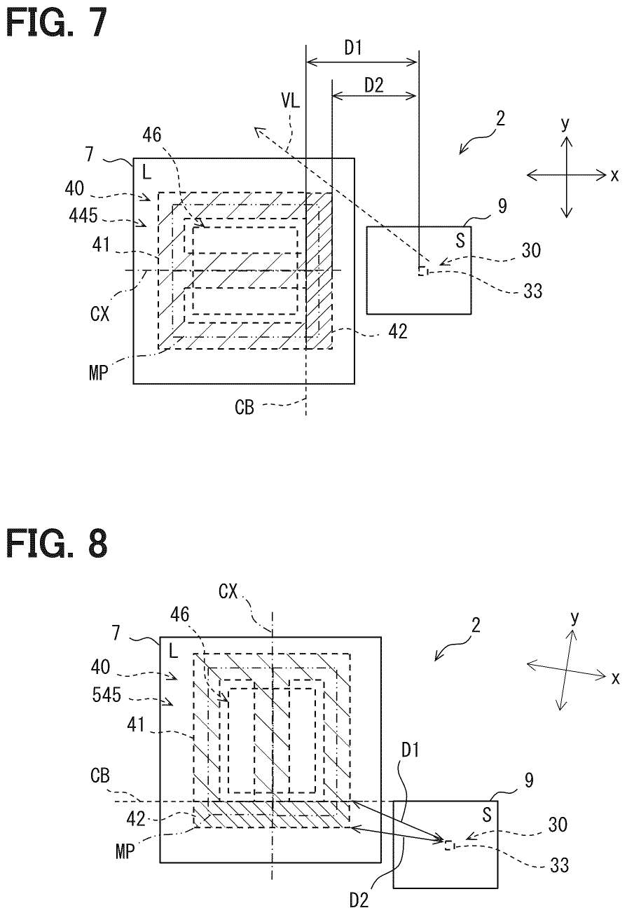

FIG. 7 shows the fourth embodiment. In the preceding embodiment, the core 45 is provided by the EE core. Alternatively, the core 445 is provided by the EI core. The first core 41 is the E-type. The second core 42 is the I-type. In this embodiment, the E-type and the I-type may be reversed. In this embodiment, too, the unevenly distributed relationship, the distance relationship, and the cover relationship are all satisfied. As a result, functions and effects similar to the first embodiment are obtained.

### Fifth Embodiment

This embodiment is a modified embodiment of the preceding embodiment which is provided as a basic embodiment.

FIG. 8 shows the fifth embodiment. The core 445 is arranged so that the core axis CX orients toward the current measurement unit 30. Alternatively, in the fifth embodiment, the core 545 is arranged so that the core axis CX does not orient toward the current measurement unit 30. In other words, the core axis CX is positioned to avoid the current measurement unit 30. The core 545 is arranged to form a distance D1 between the first core 41 and the current measurement unit 30 and a distance D2 between the second core 42 and the current measurement unit 30. In this embodiment, the adjacent direction is a slightly rightward slanting direction in the drawing. Therefore, an illustration of the x-axis in FIG. 8 is slightly rotated clockwise around the z-axis. In this embodiment, too, the unevenly distributed relationship, and the distance relationship described above are satisfied. Thus, functions and effects based on the unevenly distributed relationship and the distance relationship are obtained.

### Sixth Embodiment

This embodiment is a modified embodiment of the preceding embodiment which is provided as a basic embodiment.

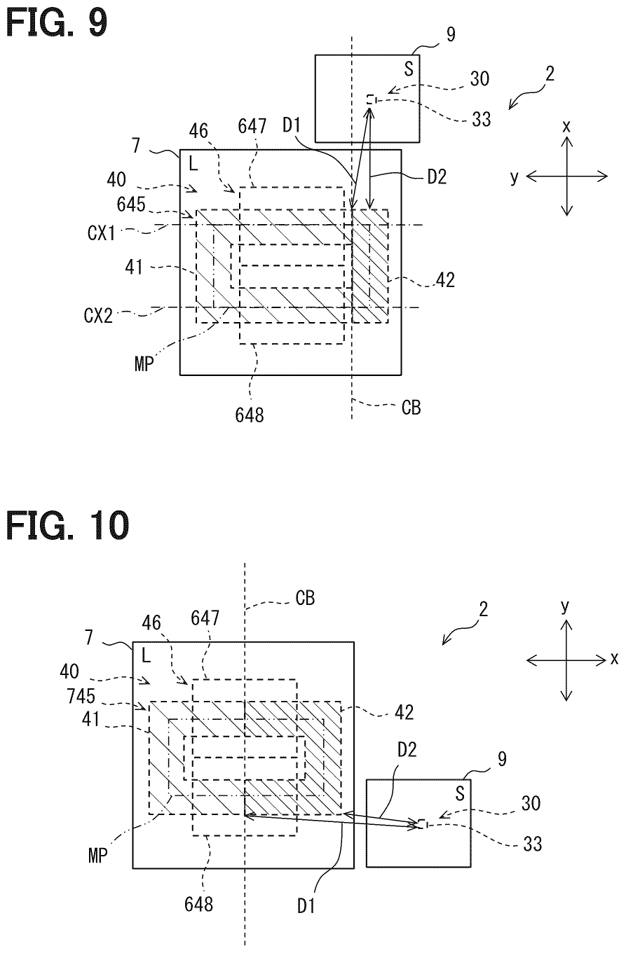

FIG. 9 shows the sixth embodiment. The core 645 is provided by the UI core. The first core 41 is the U-type. The second core 42 is the I-type. The U-type and the I-type may be reversed.

This embodiment illustrates a coil 46 with a plurality of coil portions. The coil 46 has a first coil portion 647 and a second coil portion 648. The first coil portion 647 is characterized by a coil axis CX1. The second coil portion 648 is characterized by a coil axis CX2. The coil axis CX1 and the coil axis CX2 are parallel to each other. In this embodiment, the adjacent direction is an up and down direction in the drawing. Therefore, illustrations of the axis in FIG. 9 is rotated 90 degrees counterclockwise around the z-direction. In this embodiment, too, the unevenly distributed relationship, and the distance relationship described above are satisfied. As a result, functions and effects based on the unevenly distributed relationship and the distance relationship are obtained.

### Seventh Embodiment

This embodiment is a modified embodiment of the preceding embodiment which is provided as a basic embodiment.

FIG. 10 shows the seventh embodiment. The core 745 is provided by the UU core. The first core 41 is the U-type. The second core 42 is the U-type. The first core 41 and the second core 42 are butted together in the x-direction. The first core 41 and the second core 42 may be butted together in the y-direction.

The first core 41 and the second core 42 are connected at two connecting portions. The boundary CB includes two connecting portions. The two connections are positioned in the coil 46, i.e., in the first coil portion 647 and in the second coil portion 648. In this embodiment, too, the unevenly distributed relationship, and the distance relationship described above are satisfied. As a result, functions and effects based on the unevenly distributed relationship and the distance relationship are obtained.

### Eighth Embodiment

This embodiment is a modified embodiment of the preceding embodiment which is provided as a basic embodiment.

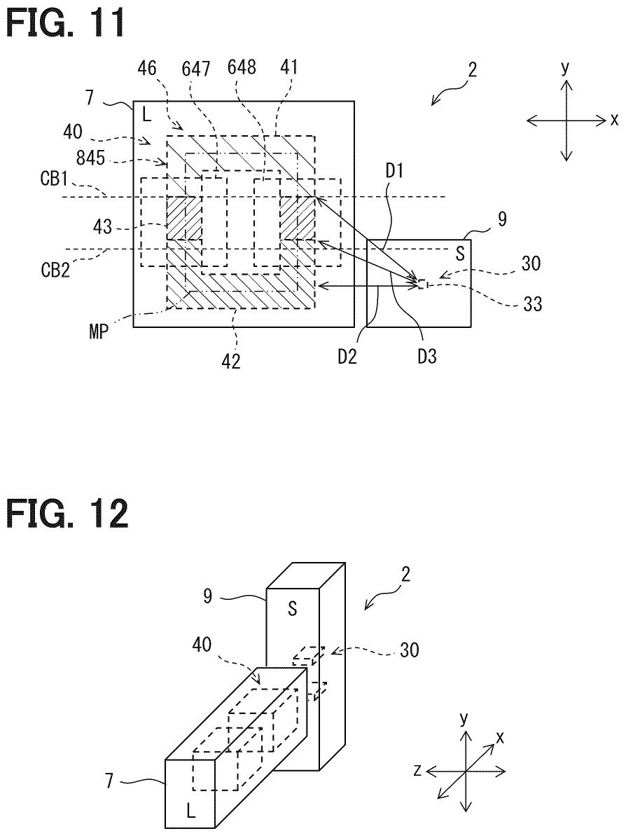

FIG. 11 shows the eighth embodiment. The core 845 is provided by combination cores that includes two I-cores in addition to the UU core. The core 845 includes a first core 41, a second core 42, and a third core 43. The first core 41 is the U-type. The second core 42 is the U-type. The third core 43 includes two portions located between the first core 41 and the second core 42. Each portion of the third core 43 is provided by the I-type.

The magnetic permeability M1 of the first core 41 is lower than the magnetic permeability M2 of the second core 42 (M1<M2). The magnetic permeability M1 of the first core 41 is lower than the magnetic permeability M3 of the third core 43 (M1<M3). The magnetic permeability M3 is also called the third magnetic permeability. The magnetic permeability M2 of the second core 42 is lower than the magnetic permeability M3 of the third core 43 (M2<M3). Therefore, the magnetic permeability M1 of the first core 41 is the smallest magnetic permeability among the partial cores that make up the core 845. The magnetic permeability M2 of the second core 42 is the middle magnetic permeability among the partial cores that make up the core 845. The magnetic permeability M3 of the third core 43 is the largest magnetic permeability among the partial cores that make up the core 845. The second core 42 has the magnetic permeability M2 that is not the minimum magnetic permeability M1 in the core 845. The third core 43 has the magnetic permeability M3 that is not the minimum magnetic permeability M1 in the core 845. Thus, the core with the magnetic permeability that is not the minimum magnetic permeability in the core 845 is the second core 42, or the third core 43, or both the second core 42 and the third core 43.

The second core 42 and the third core 43 in the core 845 may be recognized as a group of cores having the magnetic permeability M2 and M3 greater than the magnetic permeability M1 in contrast to the first core 41. Therefore, the second core 42 may be recognized to include the third core 43 having the third magnetic permeability M3 greater than the second magnetic permeability M2. The third core 43 is located between the first core 41 and the second core 42.

The first boundary CB1 is located between the first core 41 and the third core 43. The first boundary CB1 is the boundary between the magnetic permeability M1 and the magnetic permeability M3. The magnetic permeability difference at the first boundary CB1 is relatively large. The magnetic permeability difference at the first boundary CB1 is the largest of several magnetic permeability differences in the core 845. The magnetic permeability difference at the first boundary CB1 is called the first magnetic permeability difference M13.

The second boundary CB1 is located between the second core 42 and the third core 43. The second boundary CB2 is the boundary between the magnetic permeability M2 and the magnetic permeability M3. The magnetic permeability difference at the second boundary CB2 is relatively small. The magnetic permeability difference at the second boundary CB2 is the smallest of several magnetic permeability differences in the core 845. The magnetic permeability difference at the second boundary CB2 is called the second magnetic permeability difference M32.

The first magnetic permeability difference M13 is larger than the second magnetic permeability difference M32. As a result, the leakage flux in a region where the first core 41 is located with respect to the first boundary CB1 is less than the leakage flux in a region where the second core 42 and the third core 43 are located with respect to the first boundary CB1.

The current measurement unit 30 is unevenly arranged to a side of a region where the third core 43 and the second core 42 are located with respect to the first boundary CB1. Furthermore, the current measurement unit 30 is unevenly arranged to a side of a region where the second core 42 is located with respect to the second boundary CB2. As a result, the unevenly distributed relationship described above with respect to the second boundary CB2 is satisfied.

Alternatively, the current measurement unit 30 may be located between the first boundary CB1 and the second boundary CB2. In this alternative configuration, the unevenly distributed relationship is satisfied with respect to the first boundary CB1. From the viewpoint of suppressing the effect of flux leakage from the first core 41 to the current measurement unit 30, it is desirable that the above-mentioned unevenly distributed relationship is satisfied with respect to the second boundary CB2. However, even if the unevenly distributed relationship is satisfied with respect to the first boundary CB1, at least a part of functions and effects suppressing the influence caused by the leakage flux of the first core 41 may be obtained.

In this embodiment, the core 845 defines the first boundary CB1 that partitions a region where the first core 41 is located and a region where the third core 43 is located. The core 845 defines the second boundary CB2 that separates the region where the second core 42 is located from the region where the third core 43 is located. The current measurement unit 30 is unevenly arranged to a side of the region where the third core 43 is located with respect to the first boundary CB1. The current measurement unit 30 is unevenly arranged to a side of the region where the second core 42 is located with respect to the second boundary CB2.

The first core 41 and the current measurement unit 30 form therebetween the first distance D1 that is the smallest. The second core 42 and the current measurement unit 30 form therebetween the second distance D2 that is the smallest. The distance D2 is the distance in the x-direction, i.e., in the adjacent direction. The third core 43 and the current measurement unit 30 form therebetween the third distance D3 that is the smallest. The distance D1 and the distance D3 are oblique distances. The distance D1 is longer than the distance D2. The distance D1 is longer than the distance D3. The distance D2 is longer than the distance D3. The distance D1 is the longest of the several distances defined by the core 845. The distance D2 is the shortest of the several distances defined by the core 845.

The distance D1 is the distance between the first core 41 and the current measurement unit 30, which has the smallest magnetic permeability in the core 845. The distance D2 is the distance between the second core 42 and the current measurement unit 30, which has the magnetic permeability that is not the smallest in the core 845. The distance D3 is the distance between the third core 43 and the current measurement unit 30, which has the magnetic permeability that is not the smallest in the core 845. The distance D2 is shorter than the distance D1. The distance D3 is shorter than the distance D1. The distance D2 is shorter than the distance D3.

In this embodiment, too, the unevenly distributed relationship, and the distance relationship described above are satisfied. As a result, functions and effects based on the unevenly distributed relationship and the distance relationship are obtained.

### Ninth Embodiment

Relative postures of the reactor unit 7 and the sensor unit 9 may be transformed into various variants. For example, the adjacent posture illustrated in FIG. 2 may be adopted. In this adjacent posture, the reactor unit 7 and the sensor unit 9 are arranged so that the longitudinal direction (z-direction) of the reactor unit 7 and the longitudinal direction (z-direction) of the sensor unit 9 are parallel, and the reactor unit 7 and the sensor unit 9 are positioned to overlap in the adjacent direction (x-direction). The adjacent direction (the x-direction) may be a landscape direction, as illustrated in the drawing. The landscape direction may be the horizontal direction. Alternatively, the adjacent direction (the x-direction) may be the vertical direction, as illustrated in FIG. 9. The vertical direction may be an up and down direction. Further alternatively, as illustrated in FIG. 8, the adjacent direction (x-direction) may be oblique.

Furthermore, the reactor unit 7 and the sensor unit 9 may be arranged as in this ninth embodiment. This embodiment is a modified embodiment of the preceding embodiment which is provided as a basic embodiment.

FIG. 12 shows the ninth embodiment. In this embodiment, the longitudinal direction (x-direction) of the reactor unit 7 and the longitudinal direction (y-direction) of the sensor unit 9 intersect. The reactor unit 7 and the sensor unit 9 are arranged so that a surface on one end of the reactor unit 7 in the longitudinal direction and the sensor unit 9 overlap in the adjacent direction (x direction). In this embodiment, the influence of the leakage flux between the reactor element 40 located at one end of the reactor unit 7 in the longitudinal direction and the current measuring unit 30 of the sensor unit 9 is suppressed.

### Tenth Embodiment

This embodiment is a modified embodiment of the preceding embodiment which is provided as a basic embodiment. The shield members illustrated in this embodiment can be used together in other embodiments.

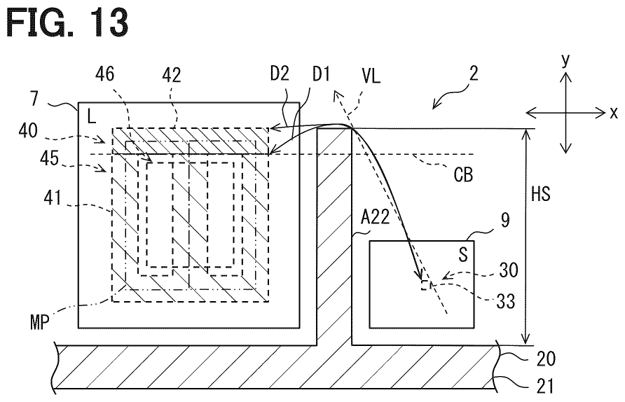

FIG. 13 shows the tenth embodiment. An electromagnetic shield material is arranged between the reactor unit 7 and the sensor unit 9, which prevents a straight linear transmission of magnetic flux. The shield member is provided by the housing 20 of the power control apparatus 2.

The housing 20 includes an outer wall member 21 that provides an outer shell. The housing 20 has a partition wall A22 extending from the outer wall member 21. The partition wall A22 is integrally formed by a common material that is continuous with the outer wall member 21. Alternatively, the partition wall A22 may be provided by a member different from the outer wall member 21.

The housing 20 and the partition wall A22 are electromagnetic shield members that block the transmission of magnetic flux. The housing 20 and the partition wall A22 are made of ferromagnetic material such as electromagnetic steel sheet. Alternatively, the housing 20 and the partition wall A22 may be made of conductive material that acts as an electromagnetic shield member by generating eddy currents. For example, the housing 20 and the partition wall A22 are made of aluminum alloy. Further alternatively, the housing 20 and the partition wall A22 may be provided by members with an electromagnetic steel plate embedded in an aluminum alloy body.

A boundary CB may be assumed between the first core 41 and the second core 42. The sensor unit 9 is located on a side of the region where the first core 41 is located with respect to the boundary CB. In this case, if the leakage flux from the first core 41 surely reach the current measurement unit 30 along a straight line, the influence of the leakage flux is strongly observed. In this embodiment, however, the influence of the leakage flux from the first core 41 is suppressed by providing a shield member by the partition wall A22.

The partition wall A22 is positioned between the reactor unit 7 and the sensor unit 9. The partition wall A22 extends over an area that completely covers the first core 41. The partition wall A22 extends from the outer wall member 21 over a height HS beyond the first core 41. The height HS of the partition wall A22 is the height above the boundary CB. The height HS of the partition wall A22 in y-direction is the height at which the partition wall A22 prevents reaching along a straight line between core 45 and current measurement unit 30. A hypothetical view line VL directed from the current measurement unit 30 to the core 45 is illustrated in the drawing. In other words, the partition wall A22 is arranged as a magnetic shield member that covers the first core 41 from the current measurement unit 30 between the core 45 and the current measurement unit 30.

FIG. 13 illustrates a detouring path of the leakage flux reaching the current measurement unit 30 from the core 45 of the reactor element 40. A length of the shortest detour path between the first core 41 and the current measurement unit 30 is the distance D1. A length of the shortest detour path between the second core 42 and the current measurement unit 30 is the distance D2. The distance D2 is shorter than the distance D1. In this embodiment, the distance relationship described above is also satisfied. As a result, functions and effects based on at least due to the distance relationship.

### Other Embodiments

In the above embodiment, the electrical component influenced by the leakage flux from the reactor element 40 may be mainly exemplified by the current measurement unit 30. However, the electrical component influenced by the leakage flux are not limited to the current measurement unit 30. The electrical component influenced by the leakage flux may be a functional component that do not contain conductive members that conducts high currents. In this case, the electrical component influenced by the leakage flux may include diverse elements such as inductance elements, control circuits, bridge circuits, sensor elements for measuring temperature, and capacitance elements. The conducting members that conduct large current correspond to the conductive members that conduct current as a control target of the power control apparatus 2. The electrical component influenced by the leakage flux may be components that function due to the power supply voltage of the control system of the power control apparatus 2. For many vehicles, e.g., 12V components or 24V components may be categorized into the category of the electrical component influenced by the leakage flux.

In the above embodiment, the reactor element 40 with a variety of core shapes are illustrated. The core shape of the reactor element 40 is not limited to the shape shown in the example. The reactor element 40 may have a distribution of magnetic permeability in an integrally molded core formed by a continuous material. In this case, in the part of the integrally molded core, it is possible to find a part with magnetic permeability M1 corresponding to the first core 41 and a part with magnetic permeability M2 corresponding to the second core 42. Even when the magnetic permeability changes gradually and continuously, the boundary can be found in a center of the changing region.

The reactor unit 7 may include magnetic shield members to reduce flux leakage to the outside. Even in such a configuration, the above described embodiments contribute to suppress the influence on the electrical component caused by the leakage flux.

The disclosure in this description, the drawings, and the like is not limited to the exemplified embodiments. The disclosure includes the illustrated embodiments and variations thereof by those skilled in the art. For example, the present disclosure is not limited to the combinations of components and/or elements shown in the embodiments. The disclosure may be provided in various combinations. The disclosure may include additional portions that can be added to the embodiments. The disclosure includes those in which the components and/or elements of the embodiments are omitted. The disclosure includes the replacement or combination of components and/or elements between one embodiment and another embodiment. The disclosed technical scope is not limited to the descriptions of the embodiments. It should be understood that a part of disclosed technical scope is indicated by recitation of claims, and includes every modification within the equivalent meaning and the recitation of the scope of claims.

The disclosure in the description, drawings and the like is not limited by the description of the claims. The disclosures in the description, the drawings, and the like encompass the technical ideas described in the claims, and further extend to a wider variety of technical ideas than those in the claims. Hence, various technical ideas can be extracted from the disclosure of the description, the drawings, and the like without being bound by the description of the claims.

(Disclosure of Technical Ideas) This specification discloses a plurality of technical ideas described in the following enumerated items. Some of the items may be described in a multiple dependent form, in which a preceding item is alternatively referenced in subsequent items. Furthermore, some of the items may be described in a multiple dependent form that refers to another item in a multiple dependent form. These items described in multiple dependent form define a plurality of technical ideas.
(Technical Idea 1) A power control apparatus controlling electric power, comprising: a conductive member (2a) to conduct current to be controlled; a reactor element (40) having a coil (46) electrically connected to the conductive member and a core (45) through which magnetic flux induced by the coil passes; and an electrical component (30) in the power control apparatus, which is influenced by leakage flux from the core, wherein the core at least includes: a first core (41) having a first magnetic permeability (M1) ; and a second core having a second magnetic permeability (M2) greater than the first magnetic permeability, wherein the first core and the electrical component form therebetween a first distance (D1) as a path of magnetic flux, and wherein the second core and the electrical component form therebetween a second distance (D2) as a path of magnetic flux, and wherein the core and the electrical component are arranged so that a distance relationship (D1>D2) where the second distance is shorter than the first distance is satisfied.
(Technical Idea 2) The power control apparatus according to Technical Idea 1, wherein the reactor element and the electrical component are arranged adjacent to each other in the power control apparatus.
(Technical Idea 3) The power control apparatus according to Technical Idea 1 or Technical Idea 2, wherein the core defines a boundary (CB, CB1) that separates a region where the first core is located from a region where the second core is located, and wherein the electrical component is unevenly arranged to a side of the region where the second core is located with respect to the boundary.
(Technical Idea 4) The power control apparatus according to any one of Technical Ideas 1-3, wherein the second core is located between the first core and the electrical component, and reaching along a straight line from the first core to the electrical component is prevented.
(Technical Idea 5) The power control apparatus according to any one of Technical Ideas 1-4, wherein the second core includes a third core (43) having a third magnetic permeability greater than the second magnetic permeability.
(Technical Idea 6) The power control apparatus according to Technical Idea 4, wherein the third core is located between the first core and the second core.
(Technical Idea 7) The power control apparatus according to Technical Idea 6, wherein the core defines a first boundary (CB1) that separates a region where the first core is located from a region where the third core is located, and a second boundary (CB2) that separates a region where the second core is located from the region where the third core is located, and wherein the electrical component is unevenly arranged to a side of the region where the third core is located with respect to the first boundary, or to a side of the region where the second core is located with respect to the second boundary.
(Technical Idea 8) The power control apparatus according to any one of Technical Idea1 1-7, wherein a magnetic shield member (A22) that covers the first core from the electrical component is arranged between the core and the electrical component.
(Technical Idea 9) The power control apparatus according to any one of Technical Ideas 1-8, wherein the electrical component includes a circuit (34a) under influence by the leakage flux, or a magnetic material (33a) under influence by the leakage flux, or both the circuit and the magnetic material.
(Technical Idea 10) The power control apparatus according to any one of Technical Ideas 1-9, wherein the electrical component is an electro-magnetic current measurement unit (30) that detects magnetic flux caused by the current flowing in the conductive member.

What is claimed is:

1. A power control apparatus controlling electric power, comprising:
a conductive member to conduct current to be controlled;
a reactor element having a coil electrically connected to the conductive member and a core which passes magnetic flux induced by the coil; and
an electrical component in the power control apparatus, which is influenced by leakage flux from the core, wherein
the core at least includes:
a first core having a first magnetic permeability ; and
a second core having a second magnetic permeability greater than the first magnetic permeability, wherein
the first core and the electrical component form therebetween a first distance as a path of magnetic flux, and wherein
the second core and the electrical component form therebetween a second distance as a path of magnetic flux, and wherein
the core and the electrical component are arranged so that a distance relationship where the second distance is shorter than the first distance is satisfied.

2. The power control apparatus according to claim 1, wherein
the reactor element and the electrical component are arranged adjacent to each other in the power control apparatus.

3. The power control apparatus according to claim 1, wherein
the core defines a boundary that separates a region where the first core is located from a region where the second core is located, and wherein
the electrical component is unevenly arranged to a side of the region where the second core is located with respect to the boundary.

4. The power control apparatus according to claim 1, wherein
the second core is located between the first core and the electrical component, and reaching along a straight line from the first core to the electrical component is prevented.

5. The power control apparatus according to claim 1, wherein
the second core includes a third core having a third magnetic permeability greater than the second magnetic permeability.

6. The power control apparatus according to claim 5, wherein
the third core is located between the first core and the second core.

7. The power control apparatus according to claim 6, wherein
the core defines a first boundary that separates a region where the first core is located from a region where the third core is located, and a second boundary that separates a region where the second core is located from the region where the third core is located, and wherein
the electrical component is unevenly arranged to a side of the region where the third core is located with respect to the first boundary, or to a side of the region where the second core is located with respect to the second boundary.

8. The power control apparatus according to claim 1, wherein
a magnetic shield member that covers the first core from the electrical component is arranged between the core and the electrical component.

9. The power control apparatus according to claim 1, wherein
the electrical component includes a circuit under influence by the leakage flux, or a magnetic material under influence by the leakage flux, or both the circuit and the magnetic material.

10. The power control apparatus according to claim 1, wherein
the electrical component is an electro-magnetic current measurement unit that detects magnetic flux caused by the current flowing in the conductive member.
